(19) United States
(12) Patent Application Publication
(10) Pub. No.: US 2002/0010826 A1
(43) Pub. Date: Jan. 24, 2002

(54) Digital memory card and apparatus for reproducing data therefrom

(75) Inventors: Kenichi Takahashi, Yokosuka-Shi (JP); Joji Naito, Yokosuka-Shi (JP); Kazuo Hikawa, Yokohama-Shi (JP)

Correspondence Address: RENNER, KENNER, GREIVE, BOBAK,, TAYLOR & WEBER, 1610 First National Tower, Akron, OH, 44308-1456, US

(73) Assignee: Victor Company of Japan, Ltd.

(21) Appl. No.: 09/901,376

(22) Filed: Jul. 9, 2001

(30) Foreign Application Priority Data
Jul. 14, 2000 (JP) 2000-213991
Aug. 24, 2000 (JP) 2000-253778

(51) Int. Cl. G06F 13/00

(52) U.S. Cl. 711/100; 711/115

(57) ABSTRACT

A digital memory card includes a first area for storing a first file set having a set of audio objects and a second area for storing a second file set including a set of sound objects. A managing area is provided in the second file set and includes data for managing the first and the second file sets. Another memory card includes a first area for storing a set of sound files having a managing area, a second area for storing a still picture file and a third area for storing a motion picture file. The managing area stores data for managing the still picture and the motion picture files separately or together. The first and second file sets and the still picture and the motion picture files can be reproduced by a reproduction apparatus. Tune information is embedded in tune data as a digital watermark, the tune information being peculiar to the tune data. The tune information is further recorded in a file provided other than the tune data. The tune data with the embedded tune information and the file with the recorded tune information are distributed. The tune data is reproduced only when the tune information in the tune data and the file match each other.

### BACKGROUND OF THE INVENTION

The present invention relates to a digital memory card such as a secure digital (SD) memory card that is a small memory card capable of storing data such as audio data and a reproduction apparatus for reproducing data from a SD card.

SD memory cards have been known as one of small card-type storage media, for storing data protected under the copyright law and also managing data such as an encryption key used for data encryption.

Since SD memory cards mostly store audio signals, they have the drawbacks such as:

(1) difficult to store motion picture signals due to small size and also small storage capacity;

(2) impossible to store MIDI signals, thus also synchronized reproduction of audio and MIDI signals impossible; and

(3) impossible to reproduce a composite of still and motion pictures.

Moreover, when SD memory cards are used for mobile phones, audio reproduction only is not usable for users in reproduction of melody signaling at an incoming call due to small storage capacity.

It is also not usable for users that music and motion pictures cannot be synchronized when SD memory cards are used for hand-held devices in transmission of still and motion pictures.

SD memory cards have also been used as storage media for storing music data which are downloaded via Internet. Music data for music distribution over Internet are formed by digitizing music signals as they are or with compression. MIDI music data are also used.

There are special file formats such as MP3 and MF for music distribution over Internet without a copy guard function against illegal copying. These files have been illegally copied and uploaded onto Internet.

### SUMMARY OF THE INVENTION

A purpose of the present invention is to provide a multi-functional Memory card for use in storing music, an apparatus for reproducing data from a Memory card and a method of protecting data stored in a Memory card from illegal access.

The present invention provides a digital memory card comprising: a first area for storing a first file set including a set of audio objects; a second area for storing a second file set including a set of sound objects; and a managing area provided in the second file set and including data for managing the first and the second file sets.

Moreover, the present invention provides an apparatus for reproducing data from a digital memory card comprising: a first reproducer to reproduce data from the Memory card including; a first area for storing a first file set including a set of audio objects; a second area for storing a second file set including a set of sound objects; and a managing area provided in the second file set and including data for managing the first and the second file sets, wherein the first reproducer reproduces the first and the second file sets managed by the data stored in the second managing area.

Furthermore, the present invention provides a digital memory card comprising: a first area for storing a set of sound files including a managing area; a second area for storing a still picture file; and a third area for storing a motion picture file, wherein the managing area stores data for managing the still picture and the motion picture files separately or together.

Moreover, the present invention provides an apparatus for reproducing data from a digital memory card comprising: a reproducer to reproduce data from the Memory card including; a first area for storing a set of sound files including a managing area; a second area for storing a still picture file; and a third area for storing a motion picture file, wherein the managing area stores data for managing the still picture and the motion picture files separately or together, and the reproducer reproduces the still picture and the motion picture files managed by the data stored in the managing area.

Furthermore, the present invention provides a method of digital watermarking comprising the steps of: embedding tune information in tune data as a digital watermark, the tune information being peculiar to the tune data; and recording the tune information in a file provided other than the tune data.

Furthermore, the present invention provides a method of tune data distribution comprising the steps of: embedding tune information in tune data as a digital watermark, the tune information being peculiar to the tune data; recording the tune information in a file provided other than the tune data; and distributing the tune data with the embedded tune information and the file with the recorded tune information.

Moreover, the present invention provides a method of tune data recording comprising the steps of: embedding tune information in tune data as a digital watermark, the tune information being peculiar to the tune data; recording the tune information in a file provided other than the tune data; and recording the tune data with the embedded tune information and the file with the recorded tune information.

Furthermore, the present invention provides a method of tune data reproduction comprising the steps of: reproducing a file in which first tune information has been recorded; and reproducing tune data in which second tune information peculiar to the tune data has been embedded as a digital watermark only when the first and the second tune information match each other.

### BRIEF DESCRIPTION OF DRAWINGS

FIG. 1 shows a preferred embodiment of SD audio and sound formats that can be stored in an SD memory card according to the present invention;

FIG. 2 illustrates sound data management;

FIG. 3 illustrates still picture and motion picture management;

FIG. 4 illustrates Waveform and audio data management;

FIG. 5 illustrates DLS data management;

FIG. 6 shows a block diagram of a preferred embodiment of an apparatus for reproducing data from an SD memory card according to the present invention;

FIG. 7 illustrates playlist track management;

FIG. 8 illustrates a playlist manager;

FIG. 9 illustrates a format of playlist manager information;

FIG. 10 illustrates a track information manager and track information stored therein;

FIG. 11 illustrates a format of track general information;

FIG. 12 illustrates a picture object manager;

FIG. 13 illustrates a video object manager;

FIG. 14 illustrates a Waveform object manager;

FIG. 15 illustrates a format of a Waveform object count information;

FIG. 16 illustrates an audio object manager;

FIG. 17 illustrates a DCL object manager;

FIG. 18 illustrates presentation data;

FIGS. 19A and 19B illustrate a still picture object;

FIGS. 20A and 20B illustrate a motion picture object;

FIGS. 21A and 21B illustrate a Waveform object;

FIGS. 22A and 22B illustrate a downloadable sound object;

FIG. 23 is flow chart indicating an operation of an apparatus for reproducing data from an SD memory card according to the present invention;

FIG. 24 is flow chart indicating a recording operation to an SD memory card according to the present invention;

FIG. 25 illustrates an ISRC structure;

FIG. 26 is a block diagram of a user hand held device according to the present invention;

FIG. 27 is flow chart indicating an operation of a music playback sequencer of the hand held device shown in FIG. 26;

FIG. 28 is flow chart indicating another operation of a music playback sequencer of the hand held device shown in FIG. 26;

FIG. 29 is a block diagram of a tune encoder section according to the present invention;

FIG. 30 is flow chart indicating an operation of tune encoder section according to the present invention; and

FIG. 31 illustrates data distribution according to the present invention.

### DETAILED DESCRIPTION OF PREFERRED EMBODIMENTS

Preferred embodiments according to the present invention will be disclosed with reference to the attached drawings.

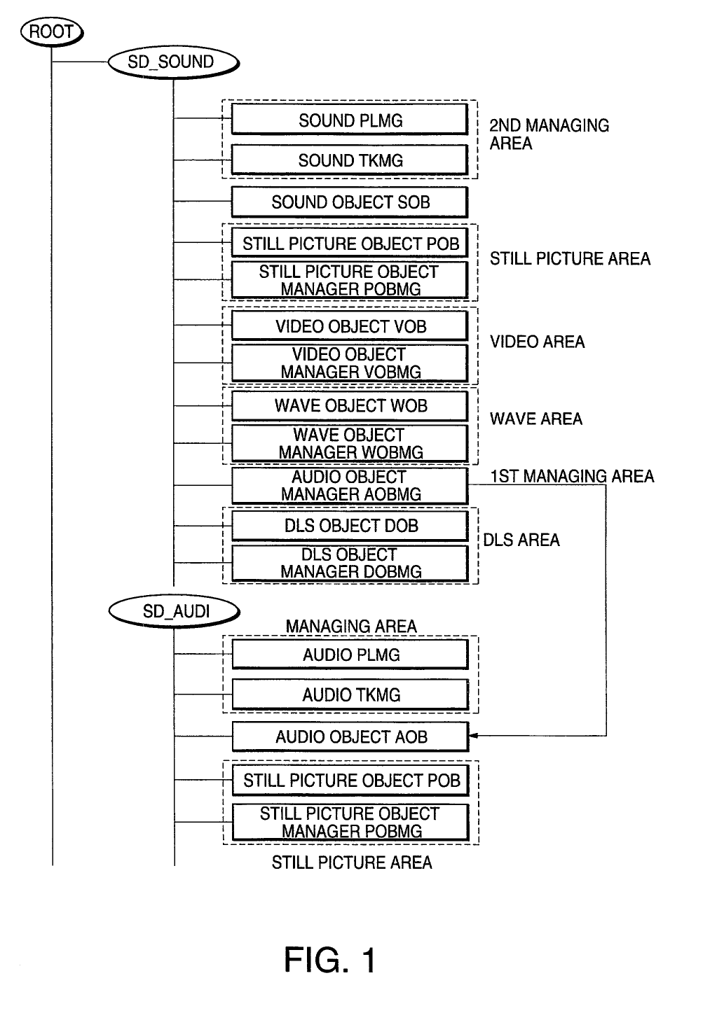

FIG. 1 shows file formats of an SD sound directory SD_SOUND (a sound object set) and a general SD audio directory SD_AUDIO (an audio object set).

A play list manager PLMG and a track information manager TKMG in the SD sound directory constitute a second managing area. A first managing area will be disclosed later. The sound PLMG in the SD sound directory includes, as shown in FIG. 8, a playlist manager information PLMGI (FIG. 9), a default playlist information DPLI and a play list information #1 to #n (n≦99).

The PLMGI includes, as shown in FIG. 9, a 2-byte PLMG identifier (PLMG_ID); a 2-byte reserved area; an 8-byte SD sound ID (SDS_ID); a 2-byte version number of sound specifications; a 2-byte number of playlist; a 4-byte track number played back first (PLMG_AP_PL); an 8-byte track number played back at last time and time from the first tune (PLMG_RSM_PL), data for resume reproduction to start reproduction again after power off at a portion of a tune that has been stopped due to power off; a 2-byte PLMG application attributes; and a 6-byte reserved area.

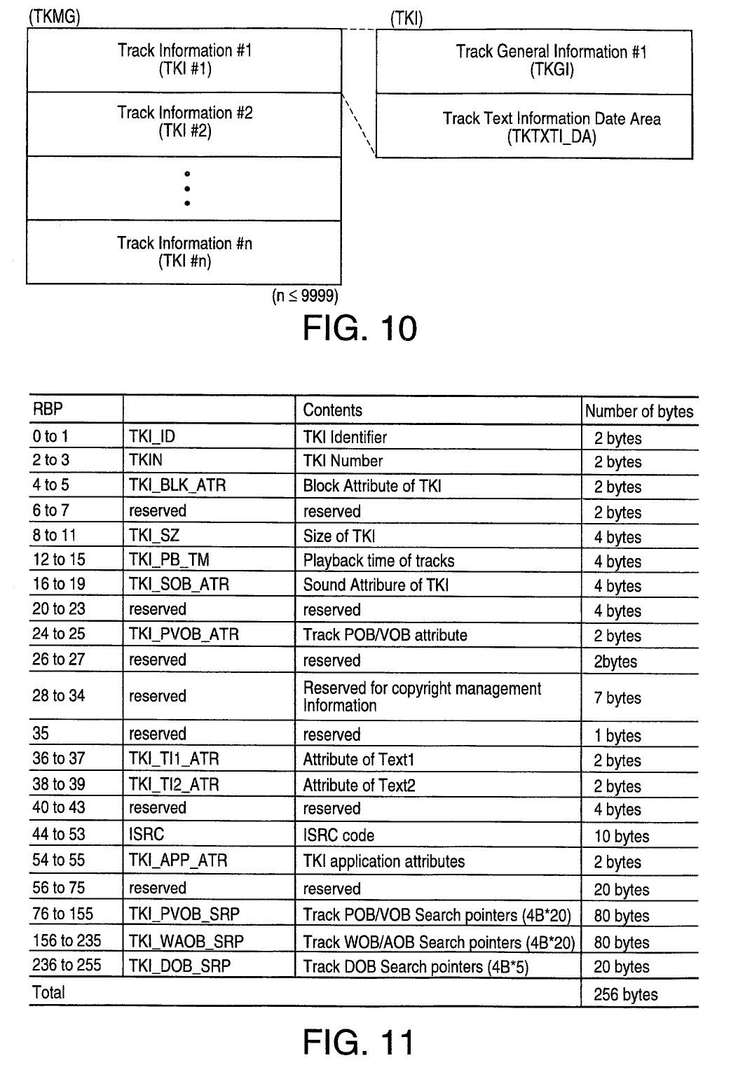

The TKMG in the SD sound directory includes, as shown in FIG. 10, track information TKI #1 to #n (n≦9999), each having a track general information TKGI (FIG. 11) and a track text information data area TKTXTI_DA.

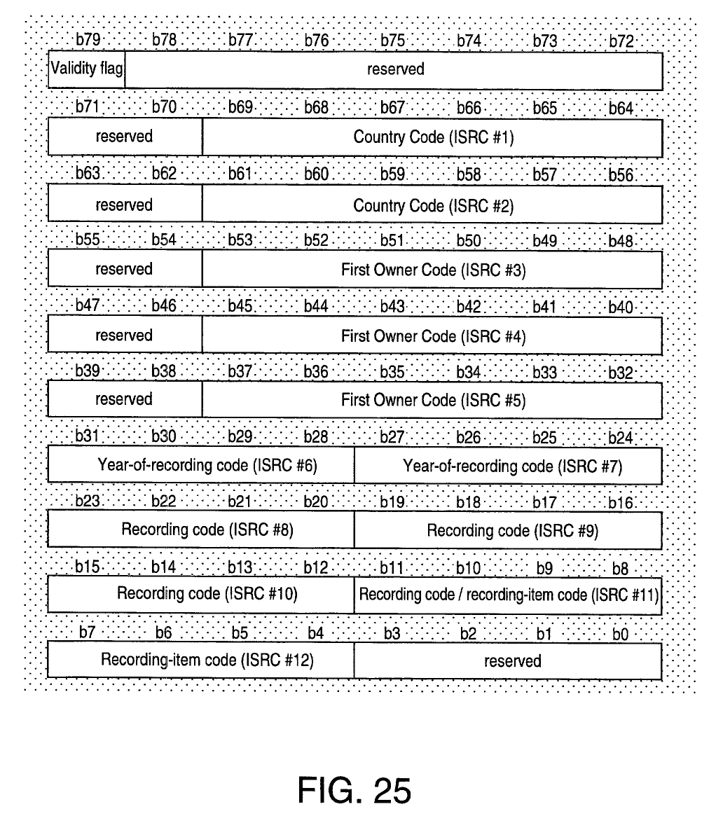

The TKGI includes, as shown in FIG. 11, a 2-byte TKI identifier (TKI_ID); a 2-byte TKI number (TKIN); a 2-byte block attribute of TKI (TKI_BLK_ATR); a 2-byte reserved area; a 4-byte size of TKI (TKI_SZ); a 4-byte playback time of tracks (TKI_PB_TM); a 4-byte sound attribute of TKI (TKI_SOB_ATR); a 4-byte reserved area; a 2-byte track POB/VOB attribute (TKI_PVOB_ATR); a 2-byte reserved area; a 7-byte reserved area for copyright management information; a 1-byte reserved area; a 2-byte attribute of text 1 (TKI_TI1_ATR); a 2-byte attribute of text 2 (TKI_TI2_ATR); a 4-byte reserved area; a 10-byte ISRC code (ISRC); a 2-byte TKI application attribute (TKI_APP_ATR); a 20-byte reserved area; an 80-byte track POB/VOB search pointer (TKI_PVOB_SRP); an 80-byte track WOB/VOB search pointer (TKI_WAOB_SRP); and a 20-byte track DOB search pointer (TKI_DOB_SRP). The ISRC code is formed as shown in FIG. 25.

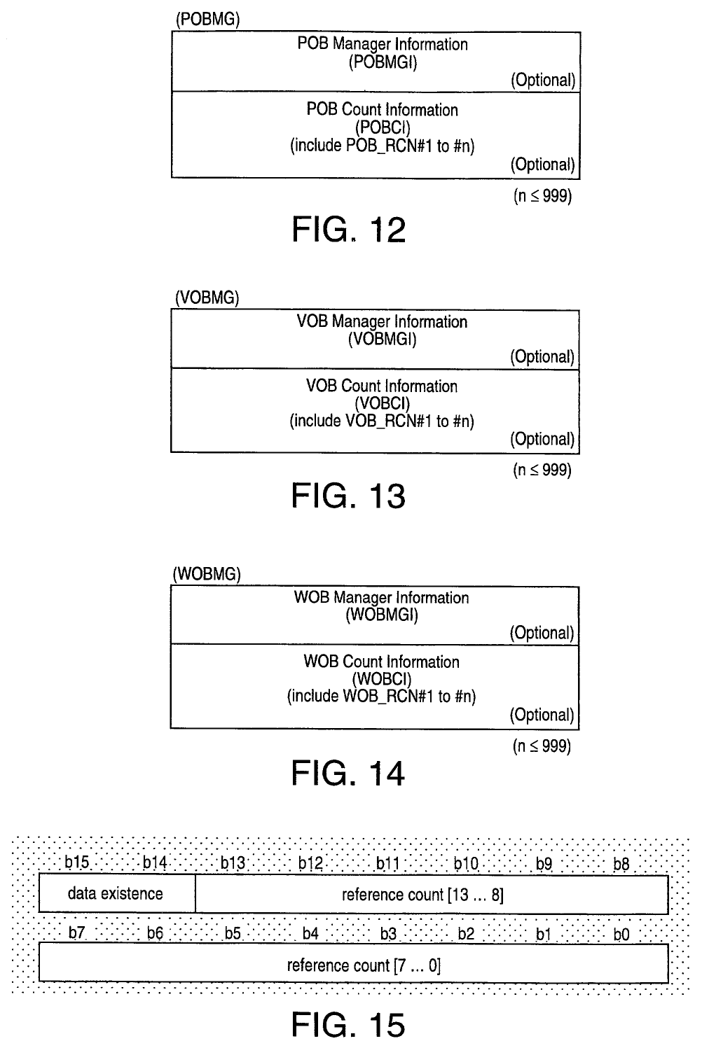

A still picture object manager POB (=POBMG) in the SD sound directory (FIG. 1) includes, as shown FIG. 12, POB manager information POBMGI and POB count information POBCI ((n≦999) that is constituted by the number of times (POB_RCN) of looking up the “n”-number of POB, 2 bytes for each, and others.

A video object manager VOM (=VOBMG) in the SD sound directory includes, as shown FIG. 13, VOB manager information VOBMGI and VOB count information VOBCI ((n≦999) that is constituted by the number of times (VOB_RCN) of looking up the “n”-number of VOB, 2 bytes for each, and others.

A Waveform object manager WOM (=WOBMG) in the SD sound directory includes, as shown FIG. 14, WOB manager information WOBMGI and WOB count information WOBCI ((n≦999) that is constituted by the number of times (WOB_RCN) of looking up the “n”-number of WOB, 2 bytes for each, and a 42-byte reserved area. The WOB_RCN (the number of times of looking up WOB) includes, as shown in FIG. 15, a 14-bit reference count and a 2-bit flag of data existence. This flag is set at 00b when there is no WOB whereas 01b when there is.

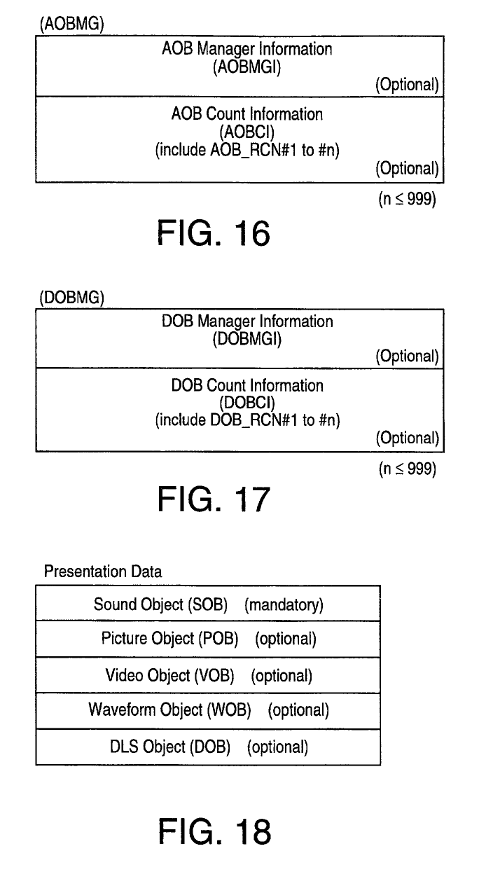

An audio object manager AOM (=AOBMG) in the SD sound directory occupies a first managing area. The AOM includes, as shown FIG. 16, AOB manager information AOBMGI and AOB count information AOBCI ((n≦999) that is constituted by the number of times (AOB_RCN) of looking up the “n”-number of AOB, 2 bytes for each, and a 42-byte reserved area. The AOB_RCN (the number of times of looking uo AOB) includes a 14-bit reference count and a 2-bit flag of data existence. This flag is set at 00b when there is no AOB whereas 01b when there is.

A DLS object manager DOM (=DOBMG) in the SD sound directory includes, as shown FIG. 17, DOB manager information DOBMGI and DOB count information DOBCI (n≦999) that is constituted by the number of times (DOB_RCN) of looking up the “n”-number of DOB, 2 bytes for each, and a 42-byte reserved area. The DOB_RCN (the number of times of looking up DOB) includes a 14-bit reference count and a 2-bit flag of data existence. This flag is set at 00b when there is no DOB whereas 01b when there is.

Each presentation data in the SD sound directory includes, as shown FIG. 18, a sound object SOB, a still picture object POB, a video object VOB, a Waveform object WOB, and a DLS object DOB. The SOB is written in a format 1.0, a standard MIDI file format SMF that support metaevents. SMF file may be compressed and processed by digital watermarking.

The still picture object POB is recorded in the following three types:

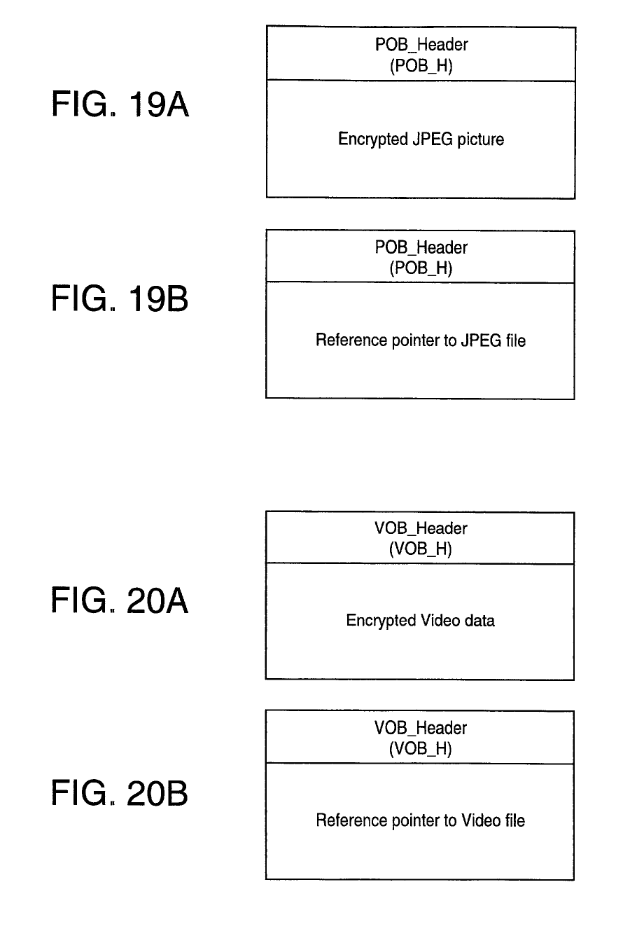

(1) encrypted JPEG (FIG. 19A) picture composed of one still picture;

(2) reference pointer to JPEG file (FIG. 19B); and

(3) JPEG picture with no header (according to Exif Ver.2.1 format).

The video object VOB is recorded in the following three types:

(1) encrypted MPEG-4 video data (FIG. 20A) composed of one continuous motion picture;

(2) reference pointer to MPEG-4 file (FIG. 20B); and

(3) MPEG-4 video data with no header (according to simple profile level 1/2/3 format).

The Waveform object WOB is recorded in the following three types:

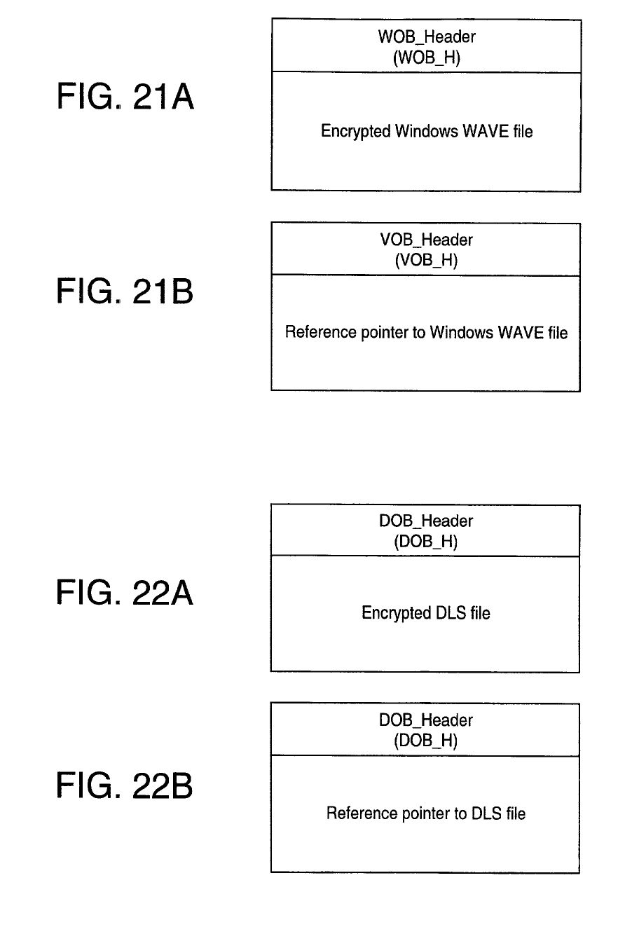

(1) encrypted Windows WAVEFORM file (FIG. 21A) composed of one sound effect;

(2) reference pointer to Windows WAVEFORM file (FIG. 21B); and

(3) Windows WAVEFORM file with no header (according to 8-/16-bit monaural/stereo format at 8/11 kHz).

The DLS (downloadable sound) object DOB is recorded in the following three types:

(1) encrypted DLS file (FIG. 22A) composed of one tone;

(2) reference pointer to DLS file (FIG. 22B); and

(3) DLS file with no header (according to level 2, Ver. 1.0 format).

The sound object SOB is provided with an ID for identifying melody signaling at an incoming call. Shown in FIG. 8 is an example of identification with application category IDs listed below and defined by DPLI application attributes DPLI_APP_ATR arranged in general information in default playlist information DPLI.

01h: music

02h: karaoke

03h: presentation

04h: reading, and

05h: melody signaling

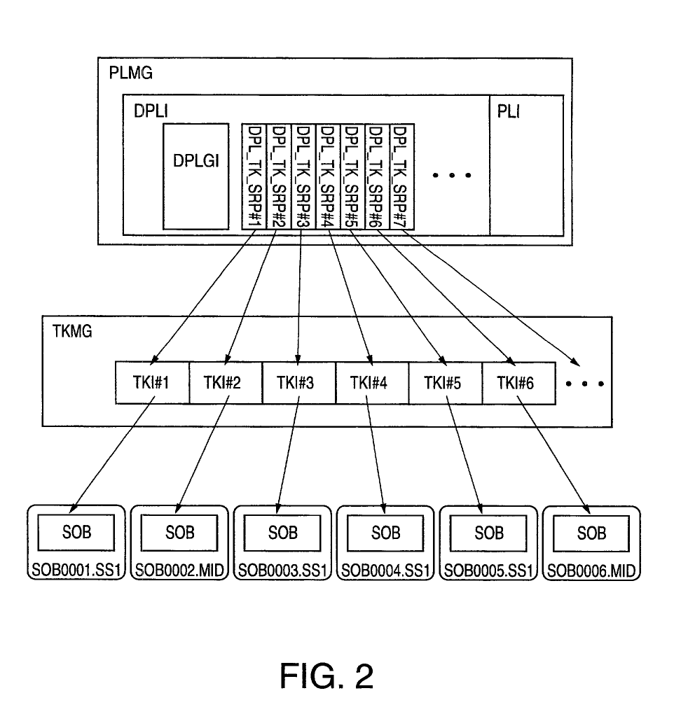

Disclosed next with reference to FIG. 2 is a reproduction process performed by a first preferred embodiment of a reproduction apparatus according to the present invention that reproduces data and files described above.

On selection of a default playlist DPLI (FIG. 8) as a playlist related to reproduction, a default playlist track search pointer DPL_TK_SRP#1 in the DPLI looks up a track information TKI #1 in the track manager TKMG (FIG. 10). The TKI #1 looks up the corresponding sound object SOB such as a SOB0001. SS1.

In the same way, a default playlist track search pointer DPL_{—TK_SRP#2 in the DPLI looks up a track information TKI #2 in the TKMG. The TKI #}2 looks up the corresponding sound object SOB such as a SOB0002. MID.

Accordingly, sound objects SOBs are successively reproduced under a designated list.

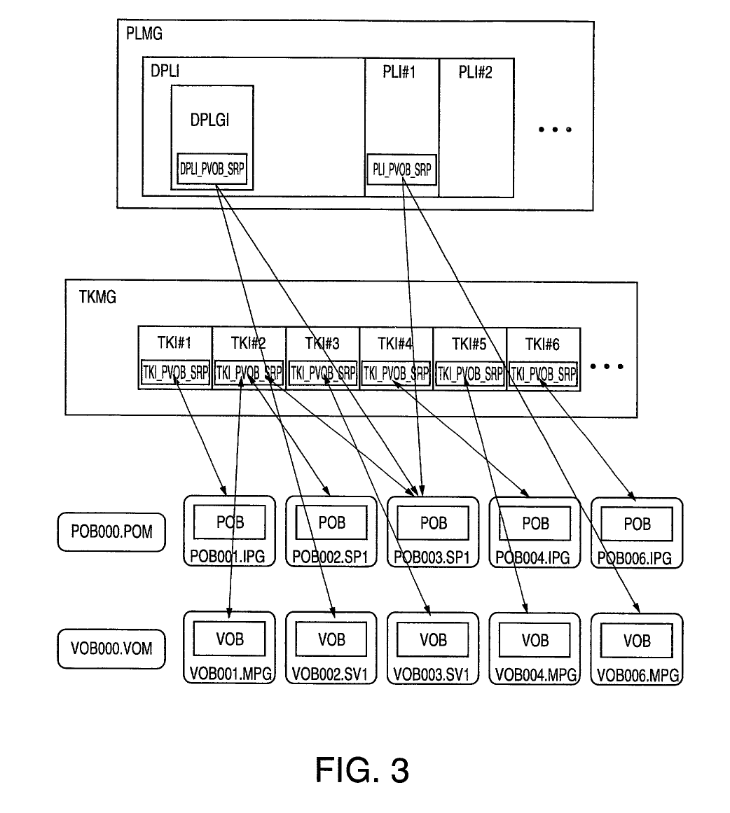

Disclosed next with reference to FIG. 3 is a reproduction process performed by a second preferred embodiment of a reproduction apparatus according to the present invention that reproduces data and files described above.

On selection of a playlist PLI#1 (FIG. 8) as a playlist related to reproduction of a composite of still and motion pictures, a playlist POB/VOB search pointer PLI_PVOB_SRP#1 in the PLI#1 looks up a track information TKI #i (i=1, 2, . . . ) in the track manager TKMG (FIG. 10).

Moreover, a default playlist POB/VOB search pointer DPLI_PVOB_SRP#1 in the header general information DPLGI of the default playlist information DPLI (FIG. 8) has also access to the track information TKI#i in the track manager TKMG (FIG. 10), which looks up the corresponding still picture object POB such as POB003. SP1, likewise, looks up the corresponding motion picture object VOB such as VOB003. SV1.

Accordingly, sound objects SOBs are successively reproduced under a designated list for simultaneous still/motion picture reproduction.

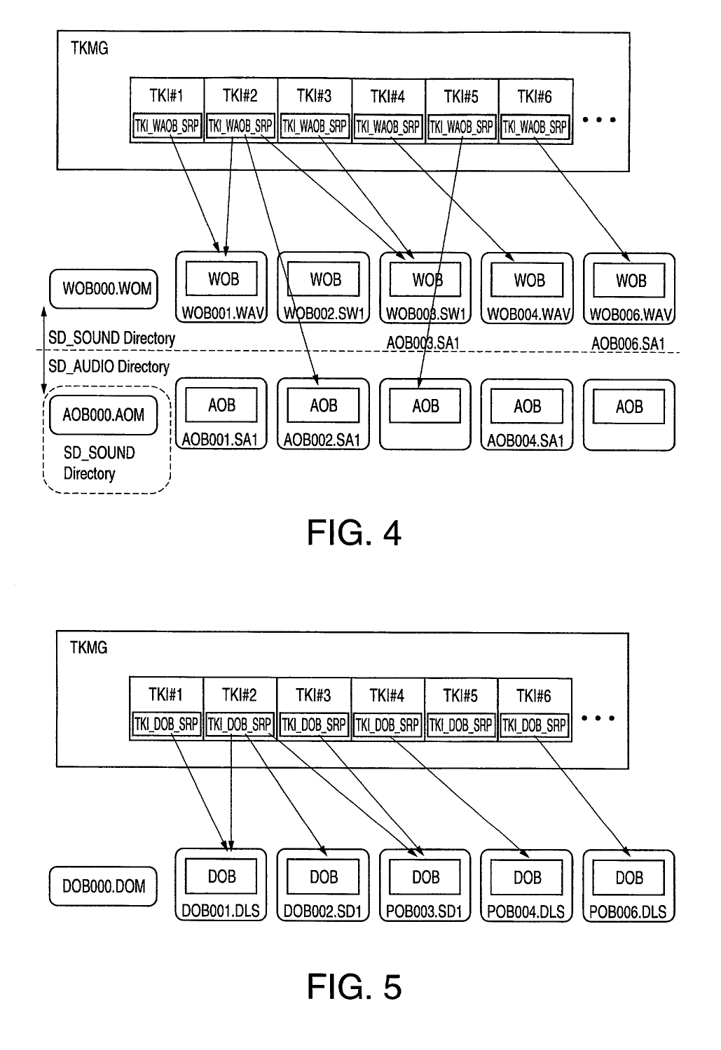

Disclosed next with reference to FIG. 4 is a reproduction process performed by a third preferred embodiment of a reproduction apparatus according to the present invention that reproduces data and files described above.

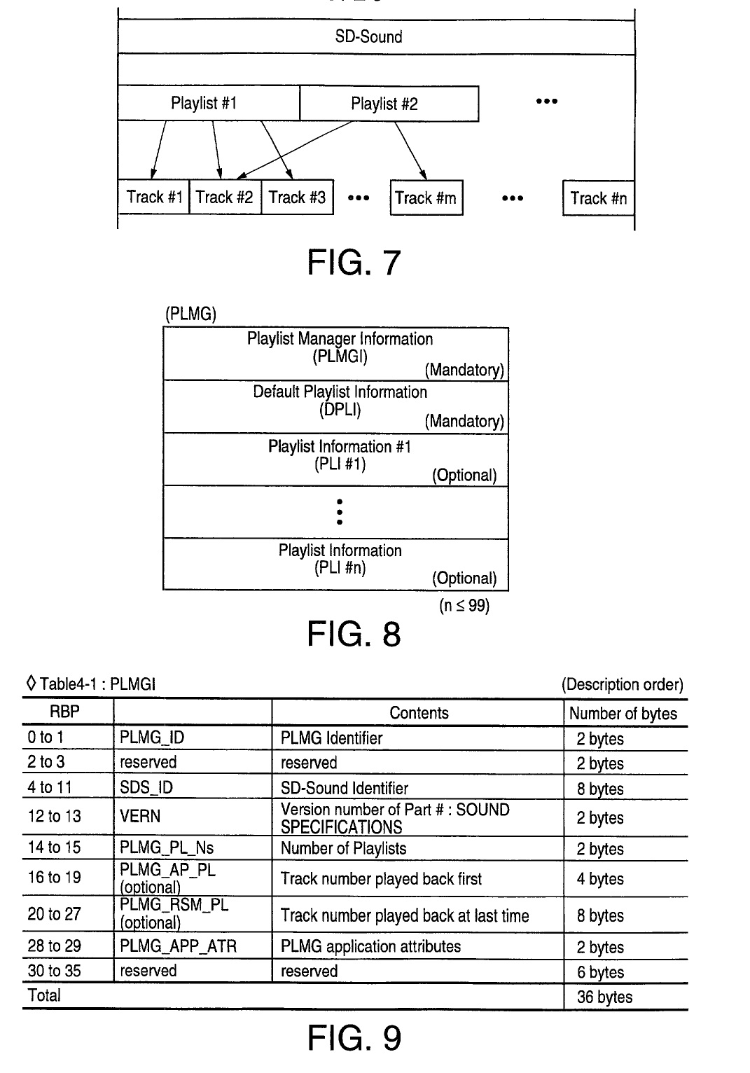

On selection of a playlist PLI#i (FIG. 7), requested by a user, as a playlist related to reproduction, a playlist track search pointer PL_TK_SRP #1 in the PLI #i looks up a track information TKI#k in the corresponding track manager TKMG (FIG. 10).

The TKI#k looks up the corresponding Waveform object WOB such as WOB001. WAV at k=1 by means of TKI_WAOB_SRP (FIG. 11), further looks up an audio manager AOM/AOBMG (FIG. 16) to have access to a designated audio object AOB in the audio directory, as indicated by an arrow in FIG. 1, for retrieving a signal such as AOB001. SA1 (audio signal) and reproducing the signal in synchronism with a Waveform object WOB001. WAV (sound effect).

In the same way, an audio object AOB is accessed according to the playlist PL#i to retrieve a signal such as AOB002. SA1 for another access to a Waveform object WOB and reproducing the signal in synchronism with a Waveform object such as WOB002. SW1.

Audio objects AOB may be deleted or overwritten with another data by a device such as an audio-only player that is not suitable for sound of these audio objects.

In overcoming such a problem, lower 12 bits of AOB byte-size are added to a track WOB/AOB search pointer TKI_WAOB_SRP in the TKI to examine the existence of an audio object AOB that is the right one and looked up by the track information TKI. The lower 12 bit data is tested for correctness so that no different AOB will not be reproduced.

Disclosed next with reference to FIG. 5 is a reproduction process performed by a fourth preferred embodiment of a reproduction apparatus according to the present invention that reproduces data and files described above.

On selection of a playlist PLI#i (FIG. 7), requested by a user, as a playlist related to reproduction, a playlist track search pointer PL_TK_SRP#1 in the PLI#i looks up a track information TKI#k in the corresponding track manager TKMG (FIG. 10).

The TKI #k looks up the corresponding DLS object DOB such as DOB001. DLS (tone data in a sound source) at k=1 by means of TKI_DOB_SRP (FIG. 11). In the same way, a DLS object DOB is accessed according to the playlist PL#i to retrieve a signal such as DOB002. SD1 for reproducing the signal with a sound signal.

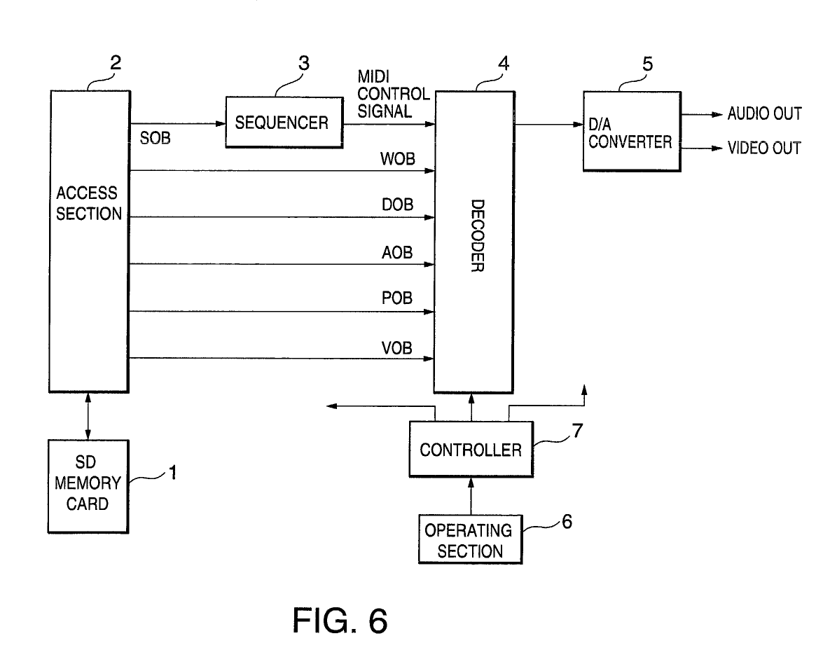

The reproduction processes according to the embodiments described above are performed by a reproduction apparatus such as shown in FIG. 6.

In operation, an access section 2 has access to a SD memory card 1 while controlled by a controller 7 that is operated by an operating section 6.

The access section 2 retrieves a sound object SOB, a main data, and sends it to a sequencer 3 for gaining a sound control signal(MIDI control signal). Moreover, the access section 2 retrieves a Waveform object WOB, a DLS object DOB, an audio object AOB, a still picture object POB, and a video object VOB and sends them to a decoder 4 with the sound control signal (MIDI control signal).

The output (digital signal) of the decoder 4 is converted into an analog signal by a D/A converter 5 and output as audio and video output.

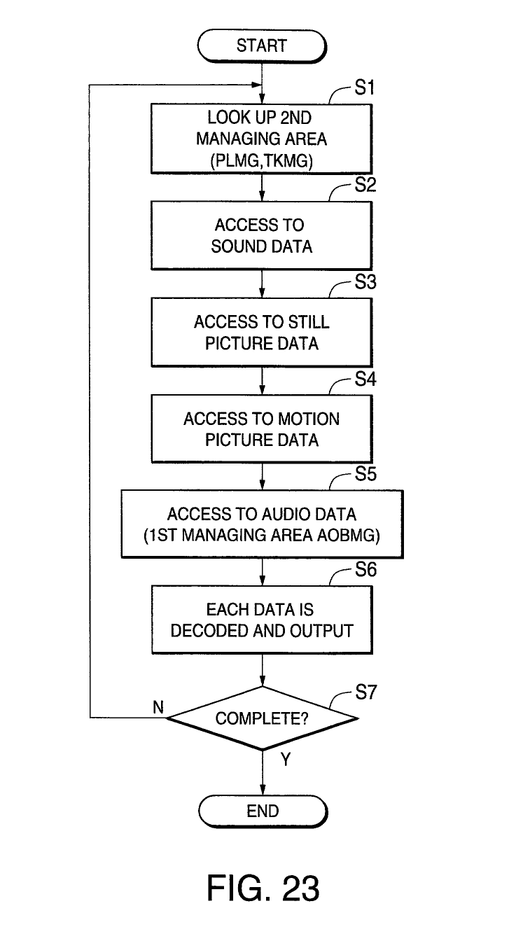

An operation of the controller 7 is disclosed in detail with reference to FIG. 23.

Managing areas are looked up (step S1) for accessing to sound data (step S2) and to still picture data (step S3), further to motion picture data (step S4) and/or audio data (step S5) if stored. Each data is decoded and output by the decoder 4 (step S6). The sequential steps are repeated if not completed (step S7).

As described above, a reproduction apparatus according to the present invention performs reproduction from a SD memory card while looking up the managing areas on the card.

Basically, 16 kinds of tones of musical instruments are simultaneously generated by one MIDI device. More than 16 tones can, however, be generated with metaevent descriptors in sound objects SOBs for switching some flies of the SOBs over several ports. The metaevent descriptors are interpreted in reproduction to distribute the SOB flies allocated to several parts to other MIDI devices for playing music with more than 16 musical instruments.

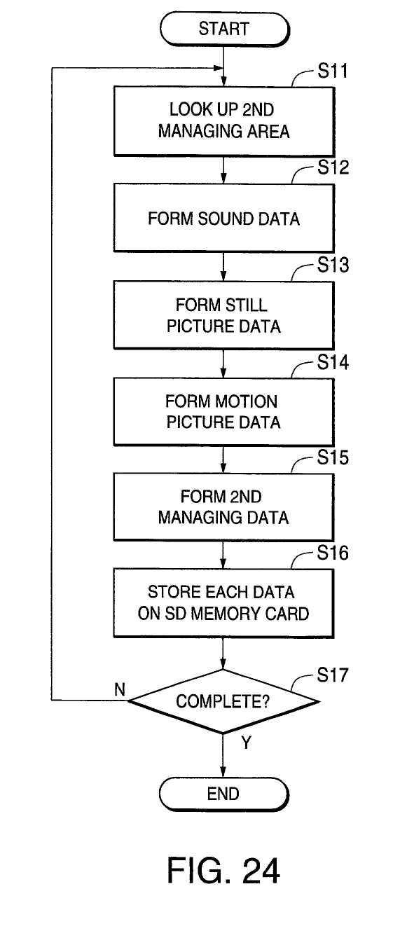

Disclosed next with reference to FIG. 24 is a method of storing data on a SD memory card.

Managing areas are looked up (step S11). Sound data, still picture data and motion picture data are formed in order (steps S12, S13 and S14). Managing data is formed for each of the sound, still picture and motion picture data (step S15). All of these data are stored on a SD memory card (step S16). The sequential steps are repeated if not completed (step S17).

The ISRC codes shown in FIG. 25 may be formed such that scrambled data are added to the reserved area (RBP56-75) instead of the ISRC area (RBP44-53) in FIG. 11. Digital watermarking may be applied to still and/or motion pictures for a matching test in reproduction.

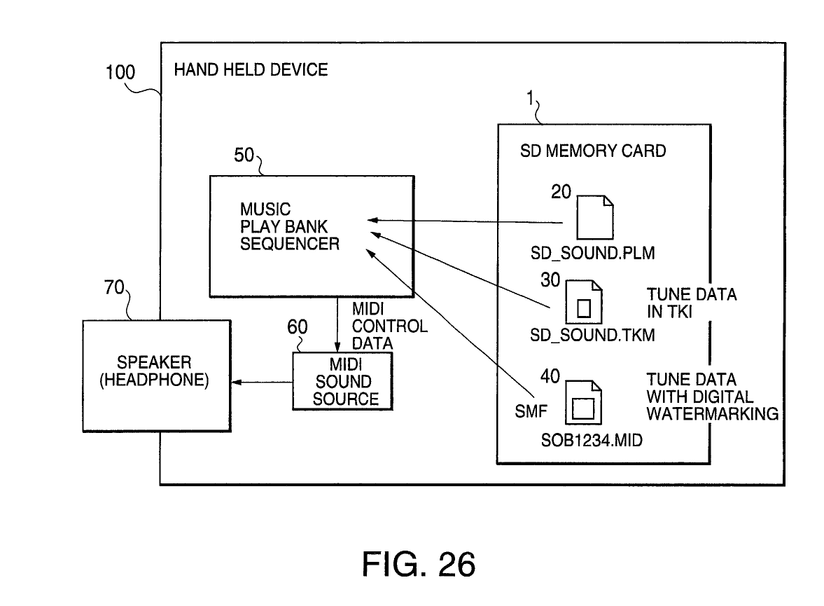

FIG. 26 shows a block diagram of a hand-held device 100 to which the SD memory card 1 (FIG. 6) is attached.

The SD memory card 1 stores an SD_SOUND. PLM file 20, an SD_SOUND. TKM file 30, an SOB1234. MID file 40 as a standard MIDI file (SMF).

Music is played back by a music playback sequencer 50, a MIDI sound source 60 and a speaker (or headphone) 70 only when ISRCs in the files 20, 30 and 40, and digital watermarked ISRC in the SMF match each other.

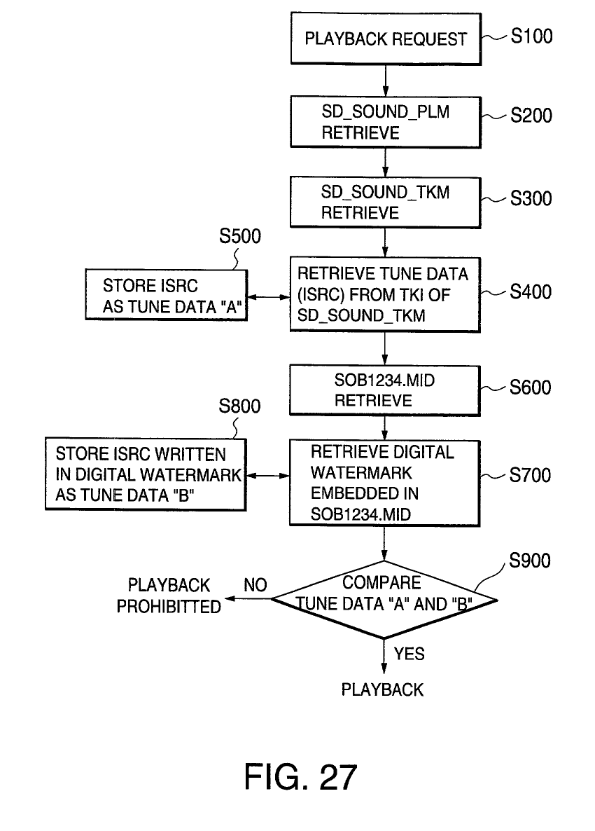

An operation of the hand-held device 100 is disclosed with reference to FIG. 27.

On request of playback (step S100), the SD_SOUND. PLM file 20 and the SD_SOUND. TKM file 30 are retrieved in order (steps S200 and S300). Tune data (ISRC) written in the TKI of the SD_SOUND. TKM file 30 is retrieved (step S400) and is simultaneously stored as tune data “A” (step S500).

The SOB1234. MIDI file 40, an SMF, is retrieved (step S600). A digital watermark embedded in the SOB1234. MIDI is retrieved (step S700) and simultaneously tune data (ISRC) written in the digital watermark is stored as tune data “B” (step S800).

The tune data “A” and “B” are compared with each other (step S900). The tune is played back when the ISRCs match each other or playback is prohibited if not match.

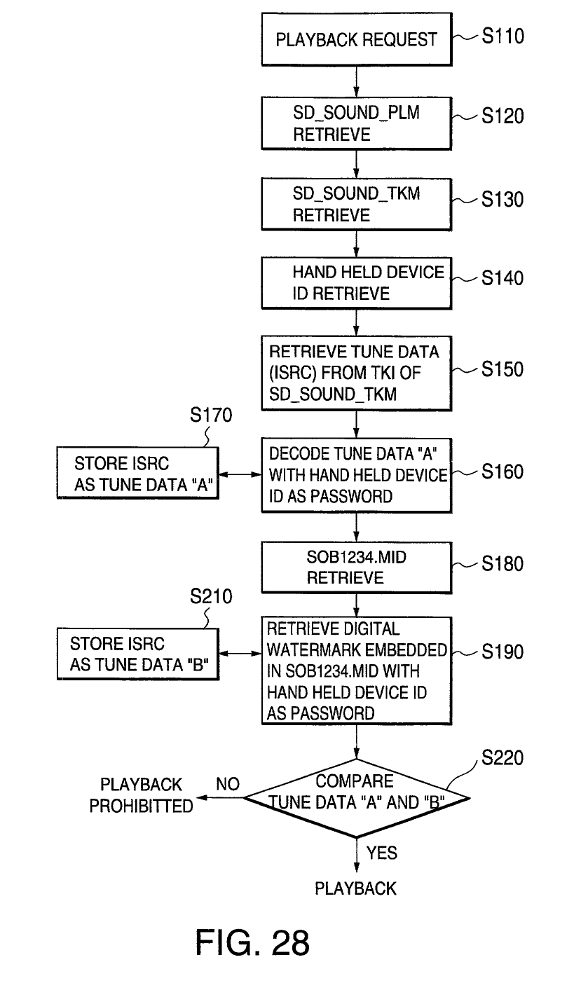

Disclosed with reference to FIG. 28 is a method of decoding the tune data “A” with an ID for the hand-held device 100 as a password.

On request of playback (step S110), the SD_SOUND. PLM file 20 and the SD_SOUND. TKM file 30 are retrieved in order (steps S120 and S130).

The ID for the hand-held device 100 is retrieved (step S140). Tune data (ISRC) written in the TKI of the SD_SOUND. TKM file 30 is retrieved (step S150) and the tune data “A” is decoded with the ID as a password and stored (steps S160 and S170).

The SOB1234. MIDI file 40, an SMF, is retrieved (step S180). Digital watermark that has been embedded in the SOB1234. MIDI with the ID as a password is retrieved (step S190) and simultaneously tune data (ISRC) written in the digital watermark is stored as tune data “B” (step S210).

The music data “A” and “B” are compared with each other (step S220). The tune is played back by the sequencer 50 (FIG. 26) for karaoke, BGM, etc., when the ISRCs match each other or playback is prohibited if not match.

As disclosed, a digital watermarking technique embeds copyright data directly in the contents of data with some changes to the contents. A portion of the contents of data itself will be damaged when the watermarked data is removed, which results in degradation of the contents. Reproduction without the watermarked data thus offers incomplete and useless contents. Such a digital watermarking technique is used for prevention of unauthorized copying.

The embodiments disclosed so far use MIDI data for tune files. Another choice for tune files is a usual digital audio file formed by recording music signals with PCM signals or compression such as AAC (advanced audio coding).

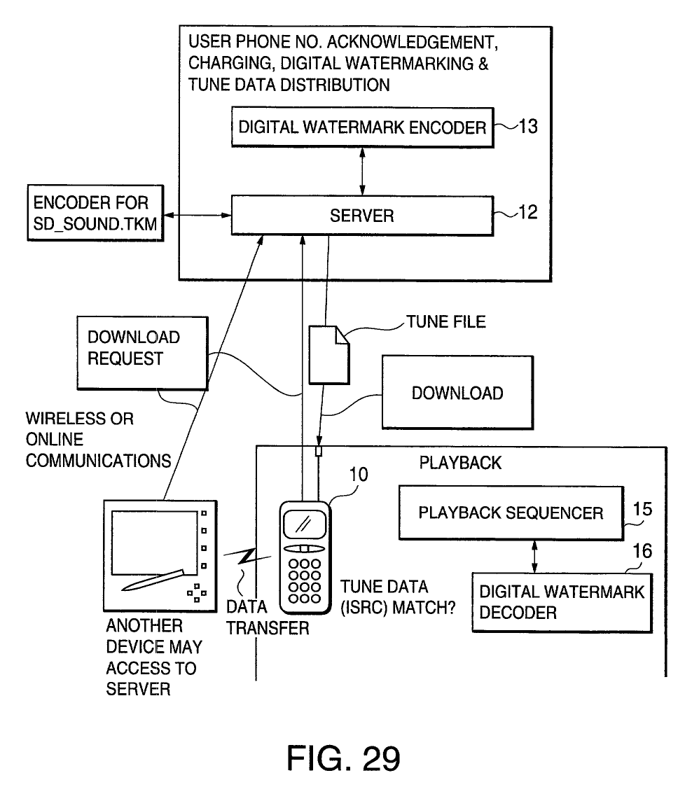

Disclosed next is tune file downloading with reference to FIG. 29.

A user selects a tune from the lists of tunes files displayed on a hand held device such as a mobile phone 10 and makes a request to a server 12 of a service provider who has distributing tune files.

The lists of tunes may have been stored in the user's mobile phone 10 or other devices such as a personal computer connectable to the mobile phone 10. Or, the lists may have been stored in the server 12.

A user can make a request for downloading via the mobile phone 10, a dedicated device or a personal computer.

The communication between the server 12 and the user's device can be made by wire or wireless communications over the Internet. A user may retrieve and select a tune without lists.

Suppose that a user makes a request for the tune “B” sung by the artist “A” via the mobile phone 10 with the phone number xxx-xxxx-xxxx.

Tune files can be used not only as ordinary tune files but also for karaoke or BGM. The mobile phone 10 thus may be provided with a MIDI sound source and a MIDI sequencer, and further functions of displaying lyrics and scenery for karaoke, which depend on users.

A user opens a menu window on the mobile phone 10 to display a menu for accessing information distribution services. Among the lists displayed on the menu window, the user selects a list for tune selection, such as a list for tune file-, karaoke- and BGM-downloading for selection of the tune “B” by the artist “A”.

When the user finds the tune “B” by the artist “A”, he or she makes a request to the server 12 via the mobile phone 10 for downloading the tune file.

The server 12 may charge the user at a user certification section (not shown) for each tune whenever the user requests. Charging can be made at the start of, during the process of downloading or charging can be made after the completion of downloading under consideration of disconnection which could occur during downloading. Or, these charging process can be combined.

When this downloading service is a membership service, each member is allowed to access the service with a password for bolstering security. When the mobile phone 10 is used, its phone number may be checked to determine whether the user is a member or not.

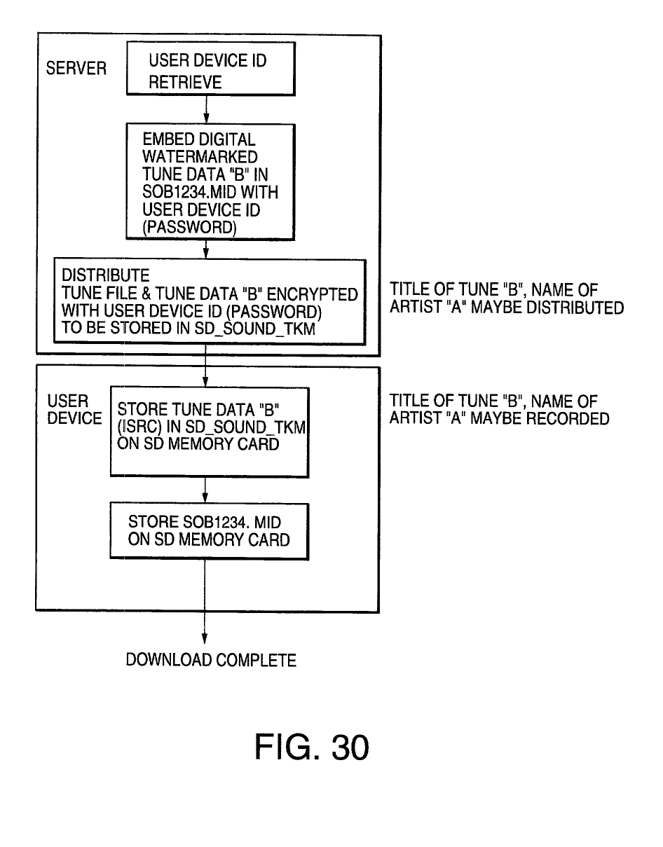

FIG. 30 shows a flowchart for tune data downloading to a SD memory card with a password.

Digital watermarked data is embedded in the tune file “B” of the artist “A” by a digital watermarking encoder 13. The digital watermarked data will be embedded in the file B temporarily when it is downloaded. In other words, it will not be embedded in the original tune “B” stored in the server 12. Therefore, the file of the tune B for the artist A will not be changed.

Each terminal has its own ID, so that it may be a heavy burden for the server 12 to perform digital watermarking and encryption for tunes whenever requested. In order to lighten such a burden, the server 12 may store watermarked tune files each having own password in addition to the original files, which get rid of issuing ID for each user's device and digital watermarking whenever requested.

The watermarked tune file is then downloaded to a SD memory card of the user device, the mobile phone 10.

When the user tries to playback tune files copied illegally on another device that is not the one via which a request for downloading has been made, playback at the other devices is failed due to difference in the contents of SD_SOUND. TKM.

Suppose that tune files embedded with digital watermarks according to the method of digital watermarking of the present invention is subjected to illegal copy onto a hard disk drive for a personal computer for use at a mobile phone other than the one for an authorized user.

It is required for such illegal use that the embedded digital watermarked data is once removed from the tune files and the phone number for the unauthorized phone is embedded instead as a watermark.

This is however technically very difficult and even if tried, the tune files will be degraded and thus useless.

An ID only for the hardware of an authorized mobile phone may be used as a digital watermark or a specific data such as a phone number may be used as a password, for further bolstered security.

According to the present invention, tune data (ISRC) is recorded in the TKI area of SD_SOUND. TKM, thus users require decoders for their devices. However, the ISRC may be recorded with no encryption or processed by a simple scrambling if the cost is high for such decoders.

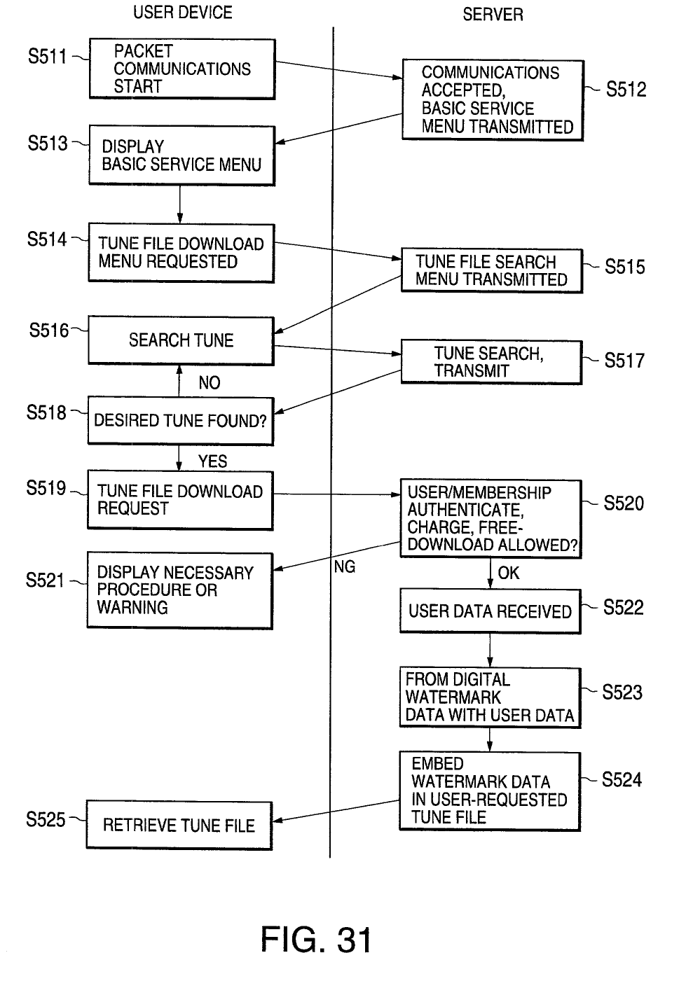

Disclosed next with reference to FIG. 31 is distribution of tune files.

Packet communications starts at the mobile phone 10 (step S511). In response to this, the server 12 transmits a basic service menu (step S512). The transmitted menu is displayed on the mobile phone 10 (step S513). A menu for downloading tune files is requested (step S514).

On receiving the request, the server 12 transmits a tune file search menu to the mobile phone 10 (step S515). The search menu is displayed on the mobile phone 10 for a user to request a desired tune file (steps S516 to S518).

A request for downloading the desired tune file is transmitted from the mobile phone 10 to the server 12 (step S519).

On receiving the request, the server 12 performs user authentication, membership authentication, charging, downloading approval processes, etc. (step S520).

When downloading is not approved, necessary process and warning, etc., are displayed on the mobile phone 10 (step S521). On the other hand, when downloading is approved, the server 12 receives the phone number or the ID of the mobile phone 10 (step S522), and embeds tune data (such as IRSC) into the tune file, as a digital watermark, with the phone number or ID as a password (step S524). The mobile phone 10 receives the tune file embedded with the watermark (step S525).

Disclosed next is a method of embedding a digital watermark.

The phone number or the ID of the mobile phone 10 is used as a password for a digital watermark and TKI, and tune files are formed with MIDI data in this invention.

The digital watermark is embedded in such a way that it is added to MIDI events of the MIDI data or the MIDI events are replaced with the watermark. The digital watermarking algorithm is, however, not limited to these ways.

The algorithm can be hidden by using a common key for encrypting the digital watermark or the MIDI data with the embedded watermark.

Usable as a common key are, for example, an ID or a password set by a user, and a hardware identification number peculiar to the mobile phone 10.

Such a common key protects the digital watermark even though MIDI data with the embedded watermark is retrieved.

A common key may be set at a fixed value such as “0000” or a password may be set for each tune if there is no need to bolster security. Not for each tune, a password may be set for each month in which tunes are released, each category of tunes or each provider for distributing tunes.

Moreover, the common key described above can be used as a password to a digital watermark added with error correction codes for encryption disclosed in Japanese Unexamined Patent Publication No. 11-302095.

When there are 8 bytes that can be embedded as a digital watermark, they can be separated into 4 bytes for expressing a phone number at 16 digits maximum. Or, a phone number once encrypted with the common key may be used as an 8-byte digital watermark.

Digital watermarking algorithms are usually susceptible to illegal access once the algorithms and data with an embedded watermark are released.

Different from usual digital watermarking, the present invention uses codes such as ISRC and in-house tune managing numbers that are impossible for users to access.

In order to use MIDI data with an embedded digital watermark according to the present invention at an unauthorized device, the embedded watermark has to be deleted and tune data such as ISRC has to be embedded again with a password such as the phone number of own mobile phone or a device ID.

Tune data such as ISRC have, however, not been released, so that it is almost impossible to get these data for use in illegal access and hence purchasing MIDI data is far more reasonable in cost, thus illegal copying, etc., can be prevented.

When the tune files disclosed so far are used for karaoke, for example, digital watermarks can be embedded in not only the tune files but also lyric displaying data and other data that will be downloaded with the tune files. Reproduction will be allowed only when all the watermarks embedded in the files and the data match each other. This further bolsters security against illegal copying.

In the present invention, MIDI data with an embedded digital watermark is stored in a track chunk in tune file format such as SMF.

As disclosed, a digital memory card according to the present invention includes a first area for storing a first file set having a set of audio objects which can be played back by an audio player and a second area for storing a second file set having a set of sound objects (MIDI signals stored therein).

The second file set has a managing area (a track manager stored therein) storing data for managing the first and the second file sets. The second file set may also have a managing area (an audio object manager stored therein) storing data for managing the first file set.

This file structure offers a multi-functional memory card for storing music.

Moreover, as disclosed, a digital memory card according to the present invention includes a first area for storing a set of sound files including a managing area, a second area for storing a still picture file and a third area for storing a motion picture file.

The managing area stores data for managing the still picture and the motion picture files separately or together.

This file structure also offers a multi-functional memory card.

Furthermore, as disclosed, in digital watermarking, tune data distribution, tune data recording and tune data reproduction according to the present invention, first tune information peculiar to tune data is embedded in the tune data as a digital watermark and second tune information is recorded in a file provided other than the tune data when stored in a digital memory card.

An ID or a phone number for a mobile phone or another user device can be used as the tune information.

Reproduction of the tune data from the memory card is allowed only when the first and the second tune information math each other.

These techniques protect tune data from illegal access.

What is claimed is:

1. A digital memory card comprising:
a first area for storing a first file set including a set of audio objects;
a second area for storing a second file set including a set of sound objects;
set of sound objects; and
a managing area provided in the second file set and including data for managing the first and the second file sets.

2. The memory card according to claim 1, wherein an audio object manager is stored in the first managing area.

3. The memory card according to claim 1, wherein a track manager is stored in the second managing area.

4. The memory card according to claim 1, wherein the second file set includes data that has been converted into a MIDI file format.

5. The memory card according to claim 1, wherein the second file set includes at least a Waveform object file that is managed by the data stored in the second managing area.

6. An apparatus for reproducing data from a digital memory card comprising:
a first reproducer to reproduce data from the memory card including;
a first area for storing a first file set including a set of audio objects;
a second area for storing a second file set including a set of sound objects;
set of sound objects; and
a managing area provided in the second file set and including data for managing the first and the second file sets,
wherein the first reproducer reproduces the first and the second file sets managed by the data stored in the second managing area.

7. The apparatus according to claim 6, wherein the second file set includes at least a Waveform object file that is managed by the data stored in the second managing area, the apparatus further comprising a second reproducer to reproduce the Waveform object file.

8. A digital memory card comprising:
a first area for storing a set of sound files including a managing area;
a second area for storing a still picture file; and
a third area for storing a motion picture file,
wherein the managing area stores data for managing the still picture and the motion picture files separately or together.

9. The memory card according to claim 8, wherein a track manager is stored in the managing area.

10. An apparatus for reproducing data from a digital memory card comprising:
a reproducer to reproduce data from the memory card including;
a first area for storing a set of sound files including a managing area;
a second area for storing a still picture file; and
a third area for storing a motion picture file,
wherein the managing area stores data for managing the still picture and the motion picture files separately or together, and
the reproducer reproduces the still picture and the motion picture files managed by the data stored in the managing area.

11. A method of digital watermarking comprising the steps of:
embedding tune information in tune data as a digital watermark, the tune information being peculiar to the tune data; and
recording the tune information in a file provided other than the tune data.

12. A method of tune data distribution comprising the steps of:
embedding tune information in tune data as a digital watermark, the tune information being peculiar to the tune data;
recording the tune information in a file provided other than the tune data; and
distributing the tune data with the embedded tune information and the file with the recorded tune information.

13. A method of tune data recording comprising the steps of:
embedding tune information in tune data as a digital watermark, the tune information being peculiar to the tune data;
recording the tune information in a file provided other than the tune data; and
recording the tune data with the embedded tune information and the file with the recorded tune information.

14. A method of tune data reproduction comprising the steps of:
reproducing a file in which first tune information has been recorded; and
reproducing tune data in which second tune information peculiar to the tune data has been embedded as a digital watermark only when the first and the second tune information match each other.
